(19) United States
(12) Patent Application Publication
(10) Pub. No.: US 2016/0330912 A1
(43) Pub. Date: Nov. 17, 2016

(54) METHOD OF REGENERATING BEARING BRANCH IN DWARFING CULTIVATION OF FURUIT

(71) Applicant: AIKI MARRON Corporation, Ibaraki (JP)

(72) Inventor: Shigemi INAGAKI, Ibaraki (JP)

(21) Appl. No.: 15/152,084

(22) Filed: May 11, 2016

(30) Foreign Application Priority Data
May 13, 2015 (JP) 2015-109157

(51) Int. Cl. A01G 1/00; A01G 17/02

(52) U.S. Cl. CPC A01G 1/001; A01G 17/023

(57) ABSTRACT

Provided is a method of regenerating a bearing branch in dwarfing cultivation of fruits, including step (1) through the step (10); and including repeating: cutting back a mother bearing branch having short bearing branches, among plural branches having grown from a bud, from which the grown fruits have been harvested, so that a bud is formed at a root end of the same mother bearing branch, and cutting back a terminal portion of a new branch by a length of one third to one fourth of the entire length of the same new branch.

### CROSS-REFERENCE TO RELATED APPLICATION

This application claims priority from Japanese Patent Application No. 2015-109157 filed with the Japan Patent Office on May 13, 2015, the entire content of which is hereby incorporated by reference.

### BACKGROUND

1. Technical Field

The present disclosure relates to a method of regenerating a bearing branch in dwarfing cultivation of fruits.

2. Related Art

The applicant has once put into practice a method of cultivating chestnuts, i.e., one type of fruit, which has been innovative as compared to a known method of cultivating. Six years have already passed since the implementation of such method, and during such period, the applicant has also been successful in cultivating and selling chestnuts that are excellent as compared to chestnuts cultivated by the known method in terms of the size, quality, yield and density. The details of the cultivating method are described in Japanese Patent No. 4953110. On the other hand, studies have been long conducted on the cultivating method similar to that of chestnuts and applicable to other fruits than chestnuts. As a result, particularly in respect of umes (Japanese apricots) and cherries, such cultivating method has enabled the harvest of unprecedented fruits.

A known fruit bearing tree tends to grow big, and the bigger the tree becomes, the less the tree is exposed to the sunlight. Therefore, many of the fruits thereof are small due to the infection with anthracnose or the like. Accordingly, e yield has been not favorable.

With respect to umes and cherries, FIG. 19 depicts a known typical method of cultivating the fruits. Specifically, branches grow from buds on a main trunk during the first year. Then, in the second year, the terminal portion of each branch is cut back by the length of one third to one fourth of the entire length of the branch. In the course of the growth during the second year, a plurality of bearing branches grows from the cut back portion. In the third year, the bearing brandies are applied with training and pruning. In the course of the growth during the third year, flower buds are generated from the trained and pruned portion. In the fourth year, fruits grow from the flower buds generated from the trained and pruned portion, and the fruits are harvested. However, according to this method, the fruits are generated from the terminal side of the branch. Therefore, the fruits may not be supplied with sufficient nutrient, a result of which may be that not many of the harvested fruits are big and of quality. In addition, every branch produces the fruits at the same time. Hence, the entire tree is less exposed to the sunlight, and the nutrient may not be sufficiently distributed.

### SUMMARY

A method of regenerating a bearing branch in dwarfing cultivation of fruits according to the present disclosure includes:

(1) growing new branches from plural buds formed on a main trunk at intervals;

(2) forming short protrusions by cutting back bearing branches having grown from the new branches at positions spaced apart from the main trunk by 3 cm to 5 cm;

(3) growing three mother bearing branches from three new branches having grown from the short protrusions;

(4) cutting back two mother bearing branches of the three mother bearing branches so that two or three buds are formed at root ends of the two mother bearing branches, and cutting back a terminal portion of the remaining mother bearing branch by a length of one third to one fourth of the entire length of the remaining mother bearing branch;

(5) growing short bearing branches from the remaining mother bearing branch, growing two new branches from the two mother bearing branches cut back to form the two or three buds, and cutting back a terminal portion of either of the two new branches by a length of one third to one fourth of the entire length of the same new brunch;

(6) growing fruits from the short bearing branches having grown in the step (5), and growing short bearing branches from a mother bearing branch having grown from the new branch cut back in the step (5);

(7) cutting back the mother bearing branch having the short bearing branches from which the fruits grown in the step (6) have been harvested, so that a bud is formed at a root end of the same mother bearing branch, and cutting back a terminal portion of the other one of the two new branches uncut in the step (5) by a length of one third to one fourth of the entire length of the same new branch;

(8) growing fruits from the short bearing branches having grown in the step (6), growing short bearing branches from a mother bearing branch having grown from the new branch cut back in the step (7), and growing a new branch from the bud formed at the root end in the step (7);

(9) cutting back the mother bearing branch having the short bearing branches from which the fruits grown in the step (8) have been harvested, so that a bud is formed at a root end of the same mother bearing branch, and cutting back a terminal portion of the new branch having grown from the bud in the step (7) by a length of one third to one fourth of the entire length of the same new branch;

(10) growing fruits from the short bearing branches having grown in the step (8), growing short bearing branches from a mother bearing branch having grown from the new branch cut back in the step (9), and growing a new branch from the bud formed at the root end in the step (9); and

repeating a cycle of the step (7) through the step (10) in this order.

### BRIEF DESCRIPTION OF DRAWINGS

FIG. 1 schematically depicts a first step of a regenerating method according to a first embodiment of the present disclosure;

FIG. 2 schematically depicts a second step of the regenerating method according to the first embodiment of the present disclosure;

FIG. 3 schematically depicts a third step of the regenerating method according to the first embodiment of the present disclosure;

FIG. 4 schematically depicts a fourth step of the regenerating method according to the first embodiment of the present disclosure;

FIG. 5 schematically depicts a fifth step of the regenerating method according to the first embodiment of the present disclosure;

FIG. 6 schematically depicts a sixth step of the regenerating method according to the first embodiment of the present disclosure;

FIG. 7 schematically depicts a seventh step of the regenerating method according to the first embodiment of the present disclosure;

FIG. 8 schematically depicts an eighth step of the regenerating method according o the first embodiment of the present disclosure;

FIG. 9 schematically depicts a ninth step of the regenerating method according to the first embodiment of the present disclosure;

FIG. 10 schematically depicts a tenth step of the regenerating method according to the first embodiment of the present disclosure,

FIG. 11 schematically depicts the final form as generated from the regenerating method according to the first embodiment of the present disclosure;

FIG. 12 schematically depicts a first step of the regenerating method according to a second embodiment of the present disclosure;

FIG. 13 schematically depicts a second step of the regenerating method according to the second embodiment of the present disclosure;

FIG. 14 schematically depicts a third step of the regenerating method according to the second embodiment of the present disclosure;

FIG. 15 schematically depicts a fourth step of the regenerating method according to the second embodiment of the present disclosure;

FIG. 16 schematically depicts a fifth step of the regenerating method according to the second embodiment of the present disclosure;

FIG. 17 schematically depicts a sixth step of the regenerating method according o the second embodiment of the present disclosure;

FIG. 18 schematically depicts a seventh step of the regenerating method according to the second embodiment of the present disclosure; and

FIG. 19 schematically depicts a known typical method of cultivating fruits.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Based on the cultivating method disclosed in Japanese Patent No. 4953110 (i.e., the method having been successful in the cultivation of chestnuts), the inventors have made the studies and researches on a new method of cultivating fruits particularly applicable to times and cherries. Consequently, the inventors have found a method of dwarfing cultivation of fruits and the like that are unprecedentedly big and of quality (i.e., fruits and the like that are more preferred by consumers) as compared to those cultivated by a known method, according to which the harvestability is enhanced while the risk of the infection with anthracnose or the like is reduced.

In the present disclosure, the first embodiment for obtaining the above goal is a method of regenerating a bearing branch in dwarfing cultivation of fruits, including:

(1) growing new branches from plural buds formed on a main trunk at intervals;

(2) forming short protrusions by cutting back bearing branches having grown from the new branches at positions spaced apart from the main trunk by 3 cm to 5 cm;

(3) growing three mother bearing branches from three new branches having grown from the short protrusions;

(4) cutting back two mother bearing branches of the three mother bearing branches so that two or three buds are formed at root ends of the two mother bearing branches, and cutting back a terminal portion of the remaining mother bearing branch by a length of one third to one fourth of the entire length of the remaining mother bearing branch;

(5) growing short bearing branches from the remaining mother bearing branch, growing two new branches from the two mother bearing branches cut back to form the two or three buds, and cutting back a terminal portion of either of the two new branches by a length of one third to one fourth of the entire length of the same new branch;

(6) growing fruits from the short bearing branches having grown in the step (5), and growing short bearing branches from a mother bearing branch having grown from the new branch cut back in the step (5);

(7) cutting back the mother bearing branch having the short bearing branches from which the fruits grown in the step (6) have been harvested, so that a bud is formed at a root end of the same mother bearing branch, and cutting back a terminal portion of the other one of the two new branches uncut in the step (5) by a length of one third to one fourth of the entire length of the same new branch;

(8) growing fruits from the short bearing branches having grown in the step (6), growing short bearing branches from a mother bearing branch having grown from the new branch cut back in the step (7), and growing a new branch from the bud formed at the root end in the step (7);

(9) cutting back the mother bearing branch having the short bearing branches from which the fruits grown in the step (8) have been harvested, so that a bud is formed at a root end of the same mother bearing branch, and cutting back a terminal portion of the new branch having grown from the bud in the step (7) by a length of one third to one fourth of the entire length of the same new branch;

(10) growing fruits from the short bearing branches having grown in the step (8), growing short bearing branches from a mother bearing branch having grown from the new branch cut back in the step (9), and growing a new branch from the bud formed at the root end in the step (9); and

repeating a cycle of the step (7) through the step (10) in this order,

The second embodiment is a method of regenerating a bearing branch in dwarfing cultivation of fruits, including:

(1) forming, on a main trunk at intervals, plural buds including a 1st bud locating at a position closest to a ground through an “n”th bud, and growing bearing branches from the buds;

(2) forming short protrusions by cutting back the bearing branches at positions spaced apart from the main trunk by 3 cm to 5 cm;

(3) growing three new branches from each of the short protrusions to form plural branches including a 1st branch located at a position closest to the ground through an “n”th branch;

(4) cutting back two new branches of the three new branches so that one or two buds are formed at root ends of the two new branches, and cutting back a terminal portion of the remaining new branch by a length of one third to one fourth of the entire length of the remaining new branch;

(5) growing short bearing branches from a mother bearing branch having grown from the remaining new branch, and growing new branches from the buds of the other two new branches;

(6) in respect of the 1st branch and a third branch sequentially counted from the 1st branch, cutting back the two new branches having grown in the step (5) so that two or three buds are formed, in respect of a 2nd branch and a third branch sequentially counted from the 2nd branch, cutting back either of the two new branches having grown in the step (5) and the mother bearing branch so that two or three buds are formed, and in respect of a 3rd branch and a third branch sequentially counted from the 3rd branch, cutting back all of the new branches and the mother bearing branch so that two or three buds are formed; and

(7) in respect of the 1st branch and the third branch sequentially counted from the 1st branch, growing fruits from the short bearing branches having grown in the step (5), in respect of the 2nd branch and the third branch sequentially counted from the 2nd branch, growing short bearing branches from a mother bearing branch having grown from the remaining new branch in the step (6) and also growing new branches from the buds of the cut-back new branch and mother bearing branch, and in respect of the 3rd branch and the third branch sequentially counted from the 3rd branch, growing new branches from the buds of the two new branches and the mother bearing branch cut back in the step (6).

The third embodiment is the method of regenerating a bearing branch in dwarfing cultivation of fruits according to the first or second embodiment, wherein a plural buds formed on the main trunk at intervals are spaced apart from one another by 30 cm, and a height of the mother bearing branch located at the highest position from the ground is 180 cm to 200 cm.

The method of regenerating a bearing branch in dwarfing cultivation of fruits according to the first embodiment of the present disclosure includes the first step to the tenth step. The fruits grow at positions closer to lateral sides of a main trunk. Therefore, the fruits are sufficiently fed with nutrient. In addition, since the fruits are sufficiently exposed to the sunlight, the risk of the infection with anthracnose or the like is reduced. Hence, the fruits that are big and of quality are obtainable. Accordingly, this method stably cultivates the fruits.

In the method of regenerating a bearing branch in dwarfing cultivation of fruits according to the second embodiment of the present disclosure, the fruits simultaneously grow on every third buds instead of simultaneously growing on all buds. In the subsequent year, the fruits simultaneously grow on the neighboring buds at intervals of two buds. In the further subsequent year, the fruits simultaneously grow on the further neighboring buds at intervals of two buds, and the same process will be continued sequentially. Accordingly, the interference by the neighboring branches is reduced, and the fruits are more sufficiently exposed to the sunlight. Consequently; more sufficiently fed with nutrient, the fruits are cultivated to be bigger and of higher quality.

Further, in the method of regenerating a bearing branch in dwarfing cultivation of fruits according to the third embodiment of the present disclosure, an interval between the neighboring buds is kept at 30 cm, and thus the interference by the neighboring branches is further reduced. Therefore, the fruits are more sufficiently exposed to the sunlight. In addition, the total height is 180 cm to 200 cm. Accordingly, the fruits are easily harvestable even by the elderly.

In the following description, the method of regenerating a bearing branch in dwarfing cultivation of fruits according to the embodiments of the present disclosure will be described in detail with reference to the attached drawings.

The generating method described below is typically applicable to umes and cherries. However, the method is also applicable to other fruits.

### EXAMPLE 1

This example is an example according to the method of regenerating a bearing branch in dwarfing cultivation of fruits as in the first embodiment.

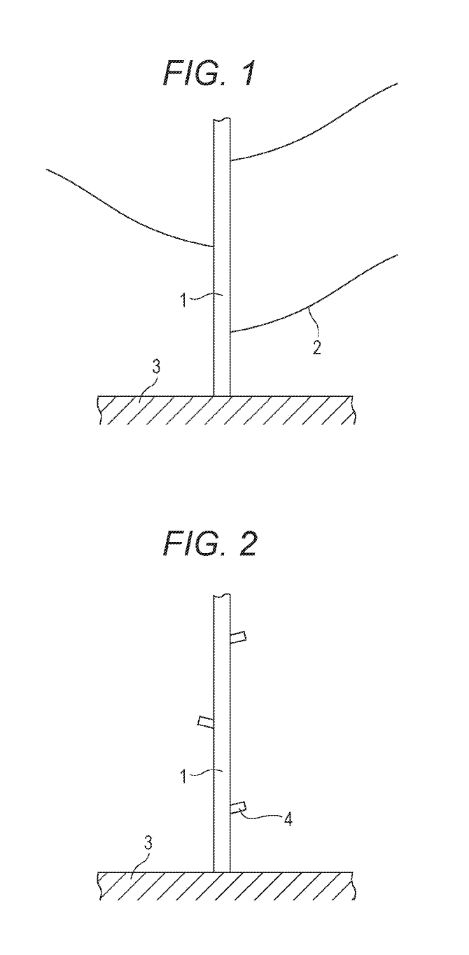

As depicted in FIG. 1, a plurality of buds grows along a main trunk 1 of a fruit plant planted in organic soil 3. From these buds, new branches 2 (i.e., first year branches) grow. The fruit plant is trained in advance so that an interval between these new branches 2 becomes, for instance, 30 cm. This step is the first step,

FIG. 2 depicts the work of training and pruning a second year tree. A bearing branch 2a growing from a new branch 2 is cut back at a position away from the main trunk 1 by 3 cm to 5 cm. By this work, a small protrusion (bud) 4 is formed. This step is the second step.

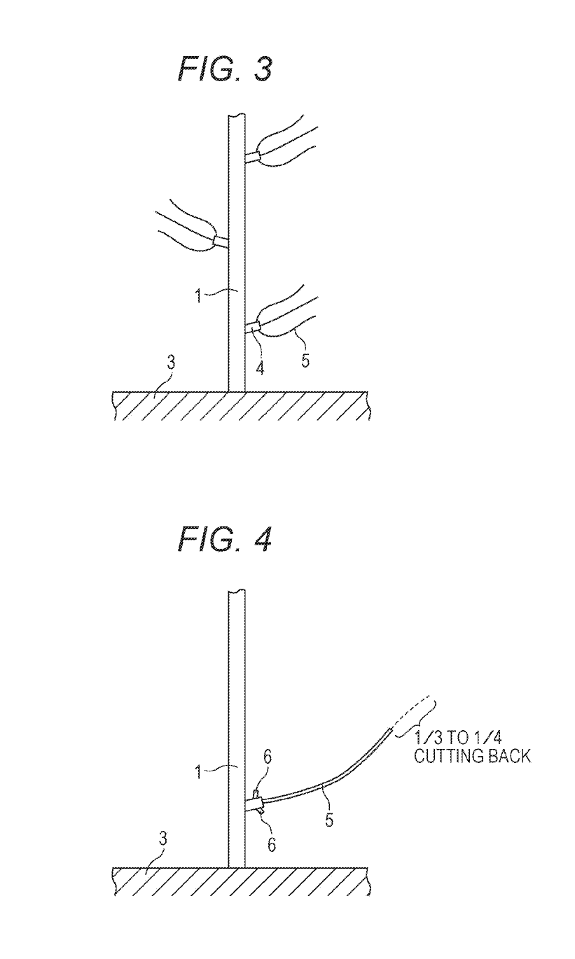

FIG. 3 depicts the third step equivalent to a step of growing the second year branch. Three new branches grow from the small protrusion (bud) 4, thereby forming three mother bearing branches 5.

FIG. 4 depicts the fourth step where the training and pruning of the third year tree are involved. Among the mother bearing branches 5 depicted in FIG. 3, two branches other than the center mother bearing branch 5 are cut back so that two or three buds 6 are formed at their root ends. Further, the terminal portion of the remaining mother bearing branch 5 is cut back by the length of one third to one fourth of the entire length of the same branch.

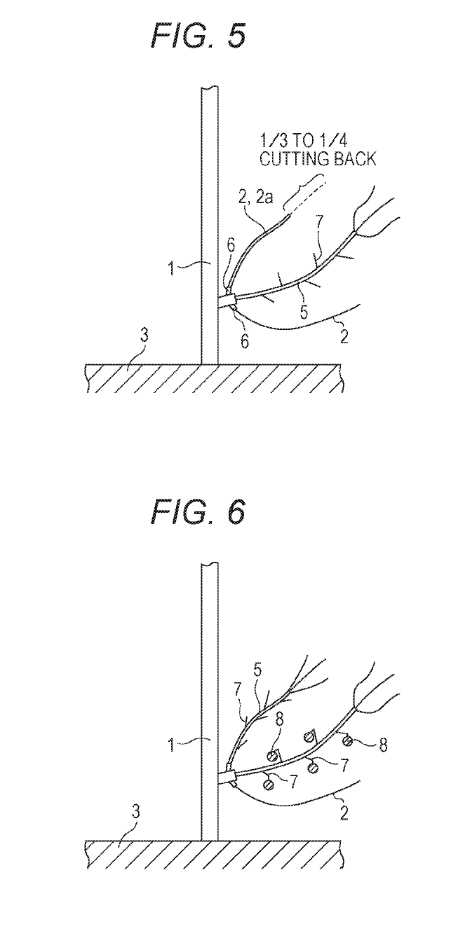

FIG. 5 depicts the fifth step equivalent to a step of growing the third year branch. Short bearing branches 7 grow from the mother bearing branch 5 depicted in FIG. 4. On the other hand, new branches 2 also grow from the buds 6 respectively. The terminal portion of either new branch 2 is cut back by the length of one third to one fourth of the entire length of the same branch.

FIG. 6 depicts the sixth step equivalent to a step of growing the four year tree. The short bearing branches 7 as described in the fifth step bear fruits 8. The new branch 2 cut back in FIG. 5 grows into a mother bearing branch 5. Short bearing branches 7 also grow from the mother bearing branch 5.

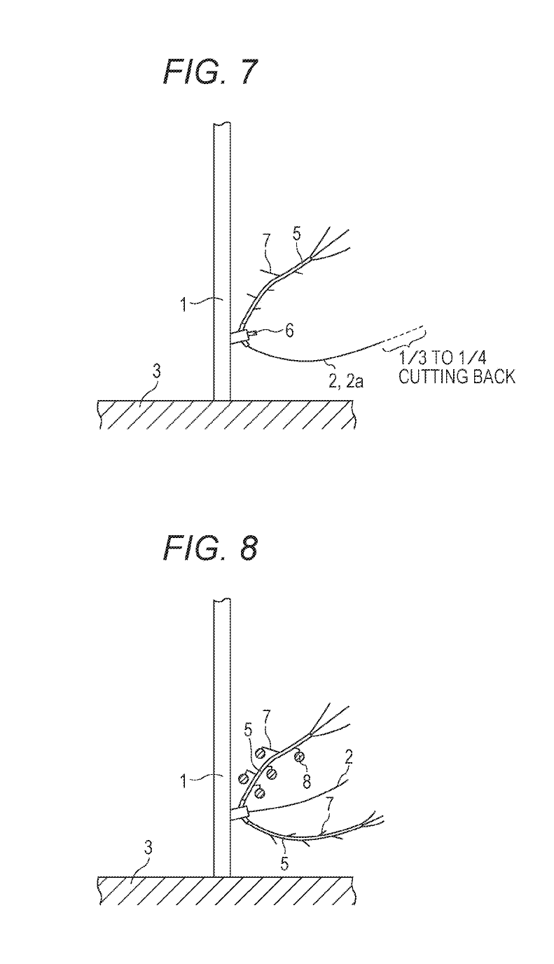

FIG. 7 depicts the seventh step equivalent to a step of training and pruning the fourth year tree. The branch from which the fruits 8 are produced in the sixth step is cut back after the fruits are harvested, so that the bud 6 is formed at a position closer to the main trunk. The terminal portion of the other new branch 2 is cut back by the length of one third to one fourth of the entire length of the same branch.

FIG. 8 depicts the eighth step equivalent to a step of growing the fifth year tree. The short bearing branches 7 bear the fruits 8. The new branch 2 cut back in FIG. 7 grows into a mother bearing branch 5. Short bearing branches 7 also grow from the mother bearing branch 5. A new branch 2 grows from the bud 6 depicted in FIG. 7.

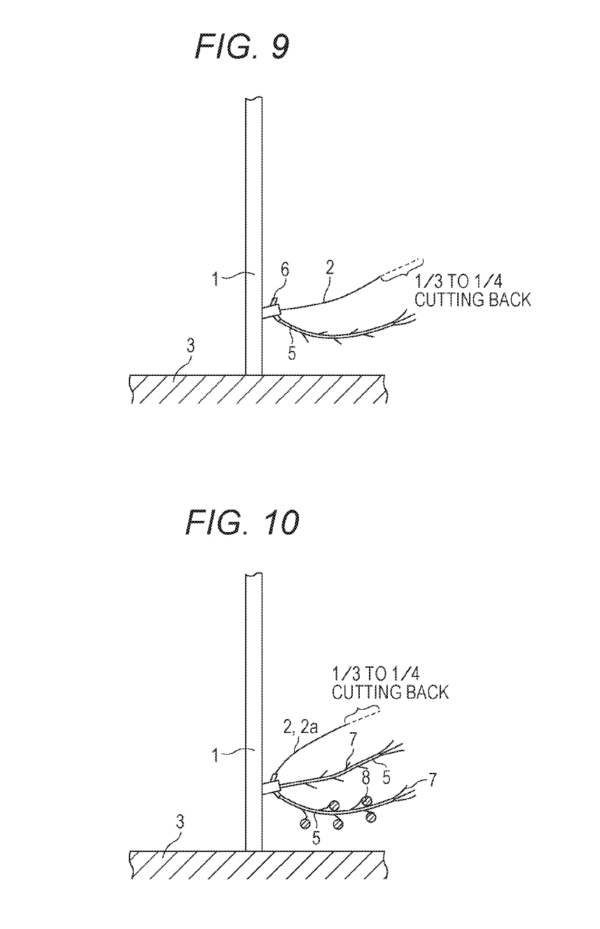

FIG. 9 depicts the ninth step equivalent to a step of training and pruning the fifth year tree. The branch from which the fruits 8 are produced in FIG. 8 is cut back so that the bud 6 is formed. The terminal portion of the new branch 2 is cut back by the length of one third to one fourth of the entire length of the same branch.

FIG. 10 depicts the tenth step equivalent to a step of growing the sixth year tree. The short bearing branches 7 bear the fruits 8. A new branch 2 grows from the bud 6 and is cut back by the one third to one fourth length thereof. Further, short bearing branches 7 grow from the branch from which the one third to one fourth length has been cut back in FIG. 9.

FIG. 11 is an illustration for describing the final form as generated according to this regenerating method. According to the third embodiment of the present disclosure, each branch group is spaced apart from one another by 30 cm. Each branch group simultaneously produces the fruits 8. At the same time, the branch groups are formed so that the height of the terminal portion of the branch located at the highest position from the ground (hereinafter referred to as “total height”) becomes 180 cm to 200 cm.

The cycle of the training, the pruning and the growing of the tree according to the sixth step depicted in FIG. 6 through the tenth step depicted in FIG. 10 is repeated every year.

### EXAMPLE 2

This example is an example according to the method of regenerating a bearing branch in dwarfing cultivation of fruits as in the second embodiment.

This embodiment relates to a method of regenerating fruits that grow from the first bud located at the lowest position of the main trunk 1 through the “n”th bud counted upward from the first bud. According to the third embodiment of the present disclosure, each bud is spaced apart from one another by 30 cm. The total height is suppressed to be 180 cm to 200 cm. Therefore, the third embodiment relates to the method of regenerating fruits that grow from the first bud through the sixth bud. Hence, in the following description, only the above instance is exemplified.

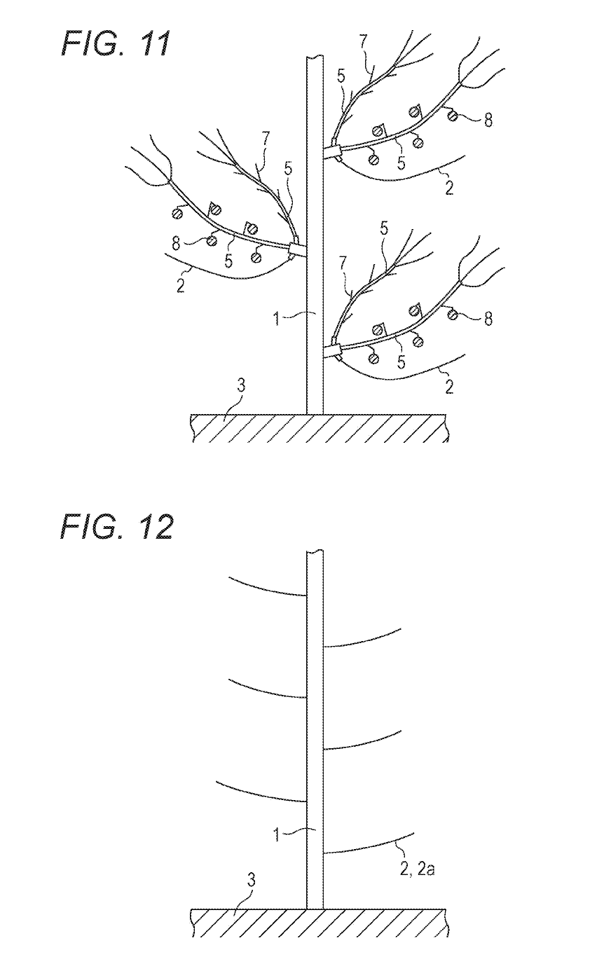

FIG. 12 depicts the first step. The main trunk 1 growing from the organic soil 3 has the bearing branches 2a that extend from the new branches 2 having grown from the first bud through the seventh bud.

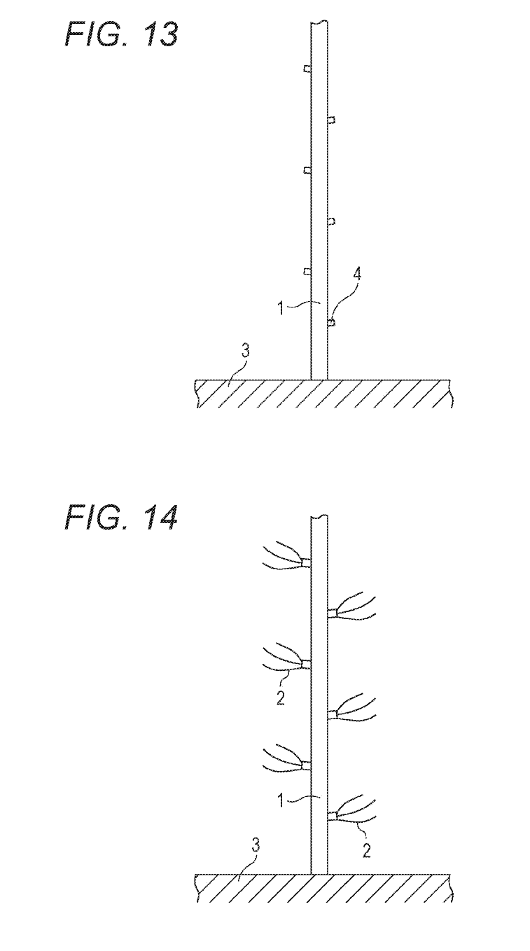

FIG. 13 depicts the second step. The bearing branches 2a are cut back by cutting off at their root ends. By this work, small protrusions (buds) 4 of 3 cm to 5 cm are formed.

FIG. 14 depicts the third step equivalent to a step of growing the second year tree. Three new branches 2 grow from each short protrusion (bud) 4.

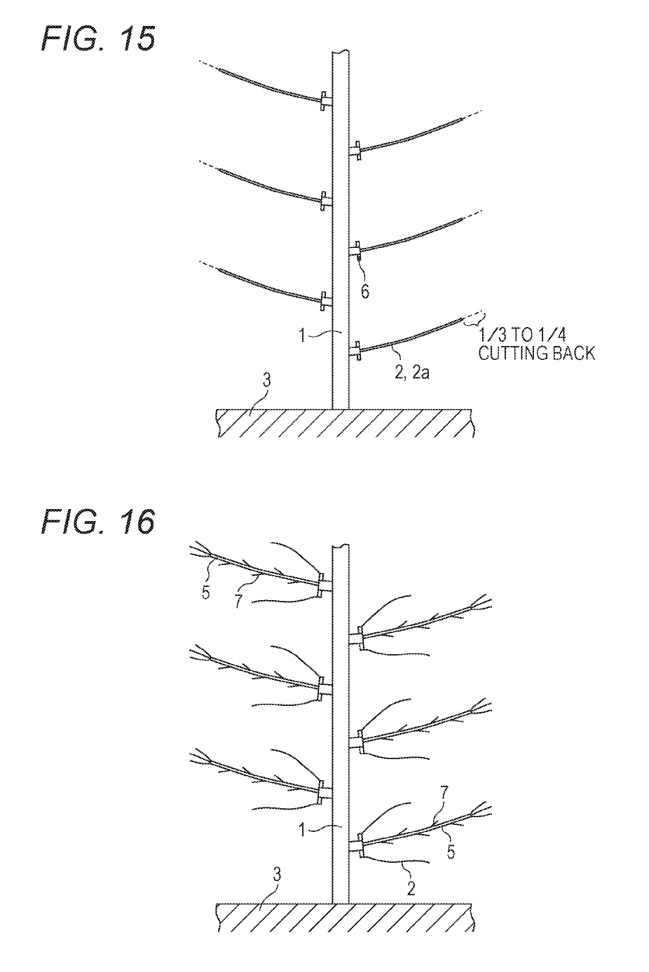

FIG. 15 depicts the fourth step equivalent to a step of training and priming the third year tree. Among the three new branches 2 in FIG. 14, the two branches other than the center new branch 2 are cut off to be cut back so that one or two buds are formed. By this work, the bud(s) 6 is formed, and the remaining new branch 2 grows into a mother bearing branch 5. The terminal portion of this mother bearing branch 5 is cut back by the length of one third to one fourth of the entire length of the same branch.

FIG. 16 depicts the fifth step equivalent to a step of growing the third year tree. Short bearing branches 7 grow from the mother bearing branch 5 cut back in FIG. 15. New branches 2 grow from the buds 6 of the two new branches 2 cut back in FIG. 15.

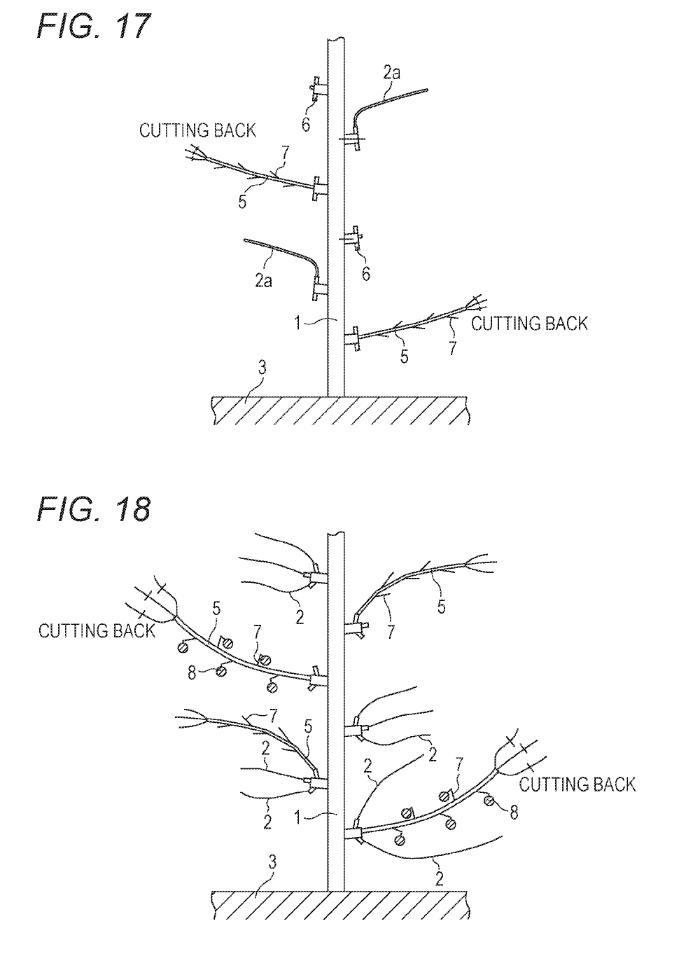

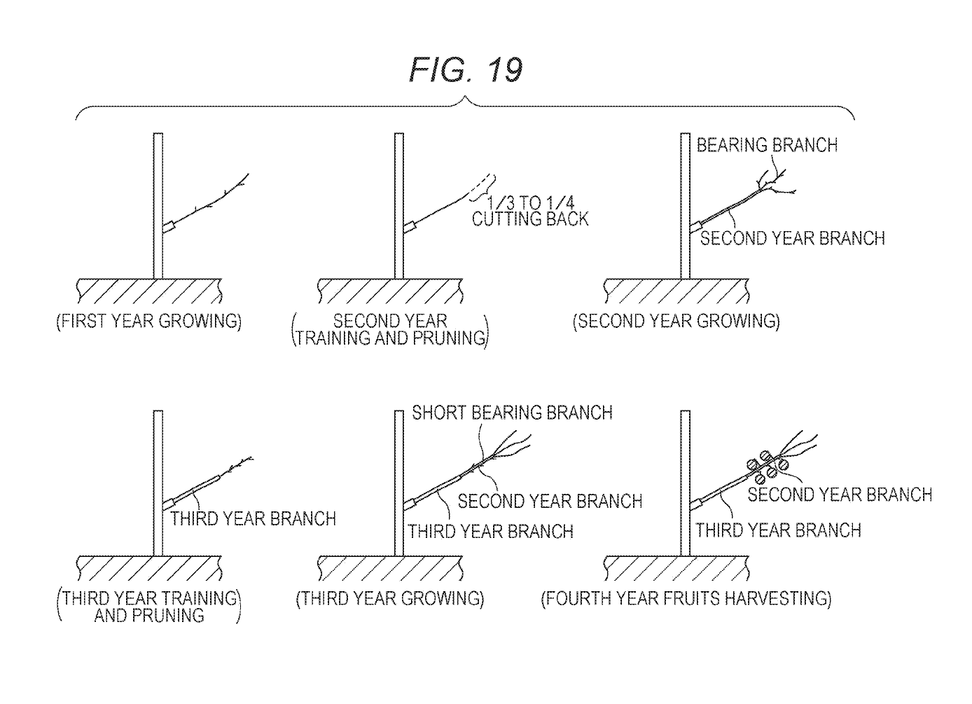

FIG. 17 depicts the sixth step equivalent to a step of training and pruning the fourth year tree, which is a core step of this embodiment (Example 2).

As depicted, in respect of the first branch and the fourth branch counted from the lower side of the main trunk 1, the mother bearing branches 5 having the grown short bearing branches 7 are remained and only their terminal portions are out back. The other two new branches 2 are cut back so that two or three buds are formed at their root ends. In respect of the second branch and the fifth branch, a single new branch 2 remains uncut. The other new branch 2 and the mother bearing branch 5 are cut back so that two or three buds are formed at their root ends. In respect of the third branch and the sixth branch, all of the new branches 2 and the mother bearing branch 5 are cut back so that two or three buds are formed at their root ends.

Fig.18 depicts the seventh step equivalent to a step of growing the fourth year tree. In respect of the first branch and the fourth branch counted from the lower side of the main trunk 1, the fruits 8 are harvested from the short bearing branches 7 thereof. In respect of the second branch and the fifth branch, the short bearing branches 7 grow from the mother bearing branch 5 that has grown from the new branch 2 uncut in FIG. 17. New branches 2 grow from the buds 6 of the other two new branches cut back in FIG. 17. In respect of the third branch and the sixth branch, new branches 2 grow from the buds 6 of the three branches cut back in FIG. 17.

Although not depicted, the fruits 8 are harvested from the second branch and the fifth branch in the subsequent year. In the further subsequent year, the fruits 8 are harvested from the third branch and the sixth branch.

This cycle will be repeated thereafter. According to this regenerating method, each branch is more exposed to the irradiation of the sunlight. Therefore, each branch is more actively fed with the nutrient. Accordingly, fruits of quality are harvestable.

### EXAMPLE 3

FIGS. 11 and 18 respectively depict the final forms of Examples 1 and 2. According to the third embodiment of the present disclosure, each bud 6 is spaced apart from the neighboring bud 6 by 30 cm. In addition, the total height of the main trunk 1 is 180 cm to 200 cm. Needless to say, when the total height of the main trunk 1 is greater than the above, each of the steps described above is likewise conducted.

The description of the method of regenerating a bearing branch in dwarfing cultivation of fruits according to the embodiments of the present disclosure has been made as in the above, but the content of the embodiments of the present disclosure is not limited to the description thus far made. It should be understood that the embodiments of the present disclosure are applicable to other techniques of the same technical fields.

The embodiments of the present disclosure are exemplarily applied to umes or cherries among fruits. However, the embodiments of the present disclosure are applicable in a wider scope. Therefore, the embodiments of the present disclosure are also applicable to other fruits such as persimmons or peaches.

Further, the method of regenerating a bearing branch in dwarfing cultivation of fruits according to the embodiments of the present disclosure may be any one of the following first to third regenerating methods.

The first method of regenerating a bearing branch in dwarfing cultivation of fruits includes: a first step of planting a fruit plant in organic soil containing organic compost or chemical compost, growing plural buds at equal intervals on a main trunk, and growing new branches from the buds as first year branches, the main trunk having grown while being fed with sunlight and soil nutrient and water from the organic soil; a second step of training and pruning a second year tree where bearing branches having grown from the new branches are cut back to be 3 cm to 5 cm long from the main trunk; a third step of growing the second year tree where three new branches grow from buds protruding by 3 cm to 5 cm to form mother bearing branches; a fourth step of training and pruning a third year tree where: two mother bearing branches of the three mother bearing branches other than one mother bearing branch are cut back so as to form two to three buds at root ends thereof; and a terminal portion of the one mother bearing branch is cut back by a length of one third to one fourth of the entire length of the same branch, the three mother bearing branches having grown from the three new branches; a fifth step of growing the third year tree where: plural short bearing branches grow from the one mother bearing branch; a terminal portion of a new branch is cut back by a length of one third to one fourth of the entire length of the same branch, the new branch being either of two new branches having grown from the two buds formed as the two or three buds; and a new branch grows from the other new branch; a sixth step of growing a fourth year tree where: fruits grow from the short bearing branches to be harvested; and short bearing branches grow from the mother bearing branch cut back by the length of one third to one fourth; a seventh step of training and pruning the fourth year tree where: the branch from which the fruits are harvested is cut back to form a bud on a main trunk side; short bearing branches grow from the mother bearing branch cut back by the length of one third to one fourth; and a terminal portion of the other new branch is cut back by a length of one third to one fourth of the entire length of the same branch; an eighth step of growing the fourth year tree where: the fruits grow from the short bearing branches to be harvested; a bearing tree grows from the mother bearing tree cut back by the length of one third to one fourth; and a new branch grows from the bud of the branch from which the fruits have been harvested in the sixth step; a ninth step of training and pruning a fifth year tree where: the branch from which the fruits are harvested is cut back to form a bud on a main trunk side; short bearing branches grow from the mother bearing branch cut back by the length of one third to one fourth; and a terminal portion of the other new branch having grown from the bud of the branch from which the fruits are harvested in the sixth step is cut back by a length of one third to one fourth of the entire length of the same branch; a tenth step of growing the fifth year tree where: the fruits grow from the short bearing branches of the ninth step to be harvested; short bearing branches grow from the branch cut back by the length of one third to one fourth in the ninth step; and a new branch grows from the bud of the ninth step; and repeating thereafter the sixth step through the tenth step.

The second method of regenerating a bearing branch in dwarfing cultivation of fruits is a method where: a fruit plant is planted in organic soil containing organic compost or chemical compost; a main trunk grows by feeding the fruit plant with sufficient sunlight and soil nutrient and water from the organic soil; plural buds of a 1st bud located at a position closest to a ground through a “n”th bud are formed on the main trunk at equal intervals; and fruits grow with reduced mutual interference of bearing branches that grow from the buds, the method including: a first step of growing bearing branches of first year branches from the buds; a second step of cutting back the bearing branches so as to form buds of 3 cm to 5 cm long on a main trunk side; a third step of growing a second year tree where three new branches grow from the buds of 3 cm to 5 cm long formed by cutting back; a fourth step of training and pruning a third year tree where: two new branches of the three new branches other than one new branch are cut back to form one or two buds and a terminal portion of the one new branch is cut back by a length of one third to one fourth of the entire length of the same branch; a fifth step of growing the third year tree where the new branch cut back by the length of one third to one fourth grows into a mother bearing branch; and short bearing branches grow from the mother bearing branch and new branches row from the buds of the other two new branches; a sixth step of training and pruning a fourth year tree where: in respect of a 1st portion and a 4th portion equivalent to the third portion counted from the 1st portion, the two new branches are cut back so as to form two or three buds while the one mother bearing branch remains uncut; in respect of a 2nd branch; the two mother bearing branches other than one mother bearing branch are cut back to form two or three buds; in respect of a 3rd branch, of the three branches are cut back so as to form two or three buds; and in respect of branches each equivalent to the third branch counted from the 2nd branch, the 3rd branch, the 4th branch and any subsequent branch, the same work is performed; a seventh step of growing the fourth year tree where: the fruits grow from the short bearing branches of the 1st branch and the 4th branch; the one new branch of the 2nd branch grows into a mother bearing branch from which short bearing branches grow while new branches grow from the two or three buds of the other two branches of the 2nd branch; and new branches grow from the two or three buds of the three branches of the 3rd branch; and applying the same growth as in the 1st branch and the 4th branch to the 2nd branch and the 3rd branch sequentially.

The third method of regenerating a bearing branch in dwarfing cultivation of fruits is the method according to the first or second method of regenerating a bearing branch in dwarfing cultivation of fruits, in which the intervals of the plural buds are 30 cm, and the total height of the final growth is 180 cm to 200 cm.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method of regenerating a bearing branch in dwarfing cultivation fruits, comprising:
(1) growing new branches from plural buds formed on a main trunk at intervals;
(2) forming short protrusions by cutting back bearing branches having grown from the new branches at positions spaced apart from the main trunk by 3 cm to 5 cm;
(3) growing three mother bearing branches from three new branches having grown from the short protrusions;
(4) cutting back two mother bearing branches of the three mother bearing branches so that two or three buds are formed at root ends of the two mother bearing branches, and cutting back a terminal portion of the remaining mother bearing branch by a length of one third to one fourth of the entire length of the remaining mother bearing branch;
(5) growing short bearing branches from the remaining mother bearing branch, growing two new branches from the two mother bearing branches cut back to form the two or three buds, and cutting back a terminal portion of either of the two new branches by a length of one third to one fourth of the entire length of the same new branch;
(6) growing fruits from the short bearing branches having grown in the step (5), and growing short bearing branches from a mother bearing branch having grown from the new branch cut back in the step (5);
(7) cutting back the mother bearing branch having the short bearing branches from which the fruits grown in the step (6) have been harvested, so that a bud is formed at a root end of the same mother bearing branch, and cutting back a terminal portion of the other one of the two new branches uncut in the step (5) by a length of one third to one fourth of the entire length of the same new branch;
(8) growing fruits from the short bearing branches having grown in the step (6), growing short bearing branches from a mother bearing branch having grown from the new branch cut back in the step (7), and growing a new branch from the bud formed at the root end in the step (7);
(9) cutting back the mother bearing branch having the short bearing branches from which the fruits grown in the step (8) have been harvested, so that a bud is formed at a root end of the same mother bearing branch, and cutting back a terminal portion of the new branch having grown from the bud in the step (7) by a length of one third to one fourth of the entire length of the same new branch;
(10) growing fruits from the short bearing branches having grown in the step (8), growing short bearing branches from a mother bearing branch having grown from the new branch cut back in the step (9), and growing a new branch from the bud formed at the root end in the step (9); and
repeating a cycle of the step (7) through the step (10) in this order.

2. A method of regenerating a bearing branch in dwarfing cultivation of fruits, comprising:
(1) forming, on a main trunk at intervals, plural buds including a 1st bud locating at a position closest to a around through an “n”th bud, and growing bearing branches from the buds;
(2) forming short protrusions by cutting back the bearing branches at positions spaced apart from the main trunk by 3 cm to 5 cm;
(3) growing three new branches from each of the short protrusions to form plural branches including a 1st branch located at a position closest to the ground through an “n”th branch;
(4) cutting back two n branches of the three new branches so that one or two buds are formed at root ends of the two new branches, and cutting back a terminal portion of the remaining new branch by a length of one third to one fourth of the entire length of the remaining new branch;
(5) growing short bearing branches from a mother bearing branch having grown from the remaining new branch, and growing new branches from the buds of the other two new branches,
(6) in respect of the 1st branch and a third branch sequentially counted from the 1st branch, cutting back the two new branches having grown in the step (5) so that two or three buds are formed, in respect of a 2nd branch and a third branch sequentially counted from the 2nd branch, cutting back either of the two new branches having grown in the step (5) and the mother bearing branch so that two or three buds are formed, and in respect of a 3rd branch and a third branch sequentially counted from the 3rd branch, cutting back all of the new branches and the mother bearing branch so that two or three buds are formed; and
(7) in respect of the 1st branch and the third branch sequentially counted from the 1st branch, growing fruits from the short bearing branches having grown in the step (5), in respect of the 2nd branch and the third branch sequentially counted from the 2nd branch, growing short bearing branches from a mother bearing branch having grown from the remaining new branch in the step (6) and also growing new branches from the buds of the cut-back new branch and mother bearing branch, and in respect of the 3rd branch and the third branch sequentially counted from the 3rd branch, growing new branches from the buds of the two new branches and the mother bearing branch cut back in the step (6).

3. The method of regenerating a bearing branch in dwarfing cultivation of fruits according to claim 1, wherein a plural buds formed on the main trunk at intervals are spaced apart from one another by 30 cm, and a height of the mother bearing branch located at the highest position from the ground is 180 cm to 200 cm.

4. The method of regenerating a bearing branch in dwarfing cultivation of fruits according to claim 2, wherein a plural buds formed on the main trunk at intervals are spaced apart from one another by 30 cm, and a height of the mother bearing branch located at the highest position from the ground is 180 cm to 200 cm.
